(19) United States
(12) Patent Application Publication
(10) Pub. No.: US 2024/0427852 A1
(43) Pub. Date: Dec. 26, 2024

(54) SYSTEMS AND METHODS FOR HIDING/UNHIDING CONTENT BASED ON METADATA CATEGORIES

(71) Applicant: Adeia Guides Inc., San Jose, CA (US)

(72) Inventors: Rajendra Pandey, Bangalore (IN); Charishma Chundi, Andhra Pradesh (IN); Reda Harb, Issaquah, WA (US)

(21) Appl. No.: 18/212,552

(22) Filed: Jun. 21, 2023

(51) Int. Cl. G06F 21/10; G06F 21/32; G06F 21/84

(52) U.S. Cl. CPC G06F 21/1066; G06F 21/32; G06F 21/84

(57) ABSTRACT

Systems and methods are disclosed herein for hiding/unhiding content based on metadata. A media application determines that one or more content items are hidden from display in a user interface. The media application may enable a safe mode for displaying content items. The media application detects an interaction corresponding to the one or more hidden content items in the user interface while the safe mode is active. The media application generates, for display in the user interface, an indicator that the one or more hidden content items are available for display.

### BACKGROUND

The present disclosure is generally directed to systems and methods for hiding/unhiding content based on metadata. In one or more aspects, the present disclosure describes hiding related content and/or temporarily unhiding the related content in various configurations.

### SUMMARY

Accessing and securing user content (e.g., photos, videos, user-generated content (UGC), etc.) are useful features for user equipment. In one approach, a user device may allow users to lock or unlock their content (e.g., authentication for a photo album via a smartphone) with a security key (e.g., passcode, PIN, lock pattern, etc.). In another approach, a device's operating system (e.g., iOS®) may allow content to be marked as hidden. In this approach, the operating system may move the content to a secure/private folder (e.g., labeled “Hidden”) to segregate the hidden content from the unhidden content. Separating the hidden content may enable, for example, a user to show their photos in their photo album while hiding private images. In some approaches, a user device may apply facial recognition and/or other machine vision techniques, for example, to identify and tag users in UGC. The identification and tagging may facilitate a search for photos including a specific user or other such queries.

However, the aforementioned approaches have limited functionality. For example, hidden images associated with a particular event or other metadata would be prevented from being displayed in a photo album unless a user manually searches and selects each image to be revealed. Further, unhiding the hidden images may require moving the selected images out of the private location in some approaches, resulting in wasted file operations. For example, a user might have captured ten images at a party and added two images to a private album, defining two photo groups where the two images are hidden as a group. A query for images of the party may miss the hidden images in this example. Some approaches may also require additional interactions to select and hide the images or other content items, which results in extra processing time associated with the additional interactions. These approaches may waste other system resources (e.g., network bandwidth, graphical processing, memory, display space, etc.) when hiding/unhiding a subset of images or other content. For example, the image data for an image may be transmitted to a device, which occupies network bandwidth, but the image may be prevented from display at the device if marked hidden. Thus, the aforementioned and other approaches have various issues and can be cumbersome, which may be frustrating for the user experience.

Accordingly, there is a need for systems and methods for securing hidden content while keeping such content conveniently accessible.

The present disclosure describes systems and methods for hiding and/or unhiding content based on metadata. One or more of the described systems and methods may enable a media application (e.g., a content album application, a messaging application, a social media application, etc.) to hide, access, and/or arrange related content items based on various content and metadata categories. As used herein, the term “hidden content” refers to content that is prevented, marked, or otherwise indicated to not be displayed (e.g., while a “Hide Content” mode is active). For example, hidden content includes content stored as a group that is marked as hidden. For example, hidden content includes content stored in a hidden portion of an album. As used herein, the term “unhidden content” refers to content that is not prevented, marked, or otherwise indicated to not be displayed. For example, unhidden content may be displayed during regular operation and while a hide content mode is active. A media application may mark unhidden content as hidden content and vice versa based on one or more criteria. Hidden content that is temporarily unhidden (e.g., by being marked as such) may be referred to as “revealed content.”

Some example content types include images, videos, audio, SMS messages, MMS messages, electronic documents, social media posts, memes, etc. Some example metadata categories include events, capture time, created date, time period, number of modifications, recently modified, recently added, location, received from one or more media sources/providers (e.g., Snapchat, Twitter, streaming, Amazon, online, live broadcast, linear, particular user profile, a social media account, etc.), object identifiers (e.g., ID tags, user face ID, animals, pets, etc.), a social group (e.g., family, co-workers, close friends), content that features a particular person or character, content from a particular sender, etc.

In some embodiments, a media application determines that one or more content items are hidden from display in a user interface. The media application may enable a safe mode for displaying content items. In some embodiments, the media application receives a selection indicative of enabling a safe mode and enables the safe mode in response to receiving the selection. The media application may detect an interaction corresponding to the one or more hidden content items in the user interface while the safe mode is active. The media application may generate, for display in the user interface, an indicator that the one or more hidden content items are available for display. The indicator may be indicative of how many content items are hidden.

In some embodiments, a media application generates an interface for displaying content in a safe mode. The media application may determine that a first content item should be hidden from display during the safe mode. The media application may identify, based on metadata of the first content item, at least a second content item being related to the first content item. The media application may prevent display of the first and second content items, and while preventing display of the first and second content items, the media application may generate, for display in the interface, an indicator that one or more related content items are hidden based on the first content item. For example, the media application may determine that a first image at an interface should be hidden during a safe mode and identify one or more content items related to the first image. As an illustrative example, the first image may be related to the other content items since the same person is depicted (e.g., based on facial recognition or the same face ID tag). The media application prevents the first image and the related content items from being displayed in the interface. The media application may generate an indicator that the related content is hidden based on the first image.

In some embodiments, a media application determines that one or more related content items are hidden from display in a user interface. For example, the hidden content items may be related to an unhidden content item displayed in the user interface. The media application may detect an interaction with the user interface. For example, the unhidden content item may be selected. For example, the media application may detect a focus on the unhidden content item (e.g., based on an eye tracking technique). Based on the interaction, the media application may generate, for display in the user interface, an indicator that the hidden related content items are available for display. In some embodiments, the media application enables access to hidden related content in response to detecting the interaction. As an illustrative example, the media application may determine that a plurality of hidden content items is related to a first video that is unhidden. The media application may detect a tap in the user interface, for example, to view the unhidden video. The media application may generate an indicator that shows there is available hidden content related to the video. The indicator may show a number of hidden content items that are available. The media application may generate an interactive option (e.g., as part of the indicator) that unhides the hidden related content upon selection of the option.

In some embodiments, a media application temporarily unhides one or more hidden content items. For example, the media application may automatically display hidden images associated with the same event or another metadata category alongside images from an unhidden album. In some instances, the media application may enable a safe mode (e.g., a safe browsing mode), which temporarily unhides the hidden content while the safe mode is active. For example, the media application may be preventing hidden content from being displayed and/or shared in a messaging interface. The media application may receive a request to activate a safe mode. During the safe mode, the media application allows the hidden content to be shared via the messaging interface. The media application may re-hide the hidden content after the safe mode is disabled (e.g., in response to receiving a subsequent request to deactivate the safe mode).

In some embodiments, a media application accesses metadata corresponding to a plurality of content items to be displayed in the user interface. The plurality of content items to be displayed may comprise the one or more hidden content items. The media application may determine that at least one metadata value from the metadata indicates the one or more hidden content items are related. The media application may update the metadata corresponding to the one or more hidden content items to comprise an identifier indicating that the one or more hidden content items are related based on the at least one metadata value. The media application may mark the one or more hidden content items as one or more related content items based on the identifier. In some embodiments, a media application may prevent display of one or more hidden content items that are unrelated to the one or more related content items.

In some embodiments, a media application automatically unhides hidden content and/or enables a safe mode based on user interactions. For example, the media application may determine that a user device is currently displaying content associated with specific date or event (e.g., a previous road trip). Previews of the content items may be displayed in a grid or other display format. The previews may be arranged or sorted in order of, e.g., most to least recently added. The media application may determine that the album includes hidden content items having previews that would be displayed at one or more positions among the unhidden previews in the grid format based on the order of arrangement. The media application may generate for display an indicator of the hidden content items at the user device.

As a result of one or more described systems and techniques, a media application may securely hide content from display and enable access to the hidden content in a conveniently accessible manner. For example, a media application may temporarily unhide, or reveal, content items based on detecting a focus on a related unhidden content item. For example, a media application may indicate in a compact manner, freeing up display space, that hidden content items are available that are related to a query. Furthermore, a media application as described herein may reduce used system resources including memory usage, computational processing, and/or graphics processing. For example, a related plurality of content items may be identified based on an input content item without a manual selection of the plurality of content items. For example, a relevant subset of hidden content items may be revealed without marking all of the hidden content items as unhidden items (e.g., by removing a hide marker from associated metadata) as in other approaches. The relevant portion may be based on being related to a particular item of interest to a user. The media application may determine the relevant portion based on comparing the metadata categories. In this manner, a relevant portion is generated for display while the unrelated content items are kept hidden, whereas unhiding all the content items as in other approaches may involve generating all the hidden items for display. In some instances, the media application may reduce the number of file operations, for example, by hiding/unhiding related content items without moving the hidden content items out of a private storage location. Thus, various embodiments of the present disclosure address the aforementioned issues and unsatisfactory aspects in other approaches.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example scenario depicting some configurations for hiding/unhiding content based on metadata, in accordance with some embodiments of this disclosure;

FIG. 2 shows an example scenario depicting a communication interface including related content sharing, in accordance with some embodiments of this disclosure;

FIG. 3 shows an example process for determining related content based on metadata, in accordance with some embodiments of this disclosure;

FIG. 4 shows an illustrative user equipment device, in accordance with some embodiments of this disclosure;

FIG. 5 shows an illustrative system for consuming content, in accordance with some embodiments of this disclosure;

FIG. 6 is a flowchart of an example process for indicating availability of hidden content based on metadata, in accordance with some embodiments of this disclosure;

FIG. 7 is a flowchart of an example process for hiding related content, in accordance with some embodiments of this disclosure; and

FIG. 8 is a flowchart of an example process for unhiding hidden content in various configurations, in accordance with some embodiments of this disclosure.

### DETAILED DESCRIPTION

The present disclosure describes one or more systems and methods for hiding, unhiding, and/or arranging display of content items based on the categories of metadata of the content. In some aspects, display of related content items may be hidden, unhidden, and/or arranged based on metadata.

As referred to herein, the term “content” should be understood to mean an electronically consumable asset accessed using any suitable electronic platform, such as broadcast television programming, pay-per-view programs, on-demand programs (as in video-on-demand (VOD) systems), internet content (e.g., streaming content, downloadable content, Webcasts, etc.), video clips, audio, information about content, images, animations, documents, playlists, websites and webpages, articles, books, electronic books, blogs, multimedia messages, chat sessions, social media, software applications, games, virtual reality media, augmented reality media, and/or any other media or multimedia and/or any combination thereof. Extended reality (XR) content refers to augmented reality (AR) content, virtual reality (VR) content, hybrid or mixed reality (MR) content, and/or other digital content combined therewith to mirror physical world objects including interactions with such content. As referred to herein, the term “visual content” and “visual content item” should be understood to mean content comprising a visual component and associated display properties (e.g., an image, a video, a slideshow, a thumbnail, cover art, a preview, etc.).

As referred to herein, the term “safe mode” and associated phrases should be understood as an interface configuration (e.g., browsing, messaging, selecting, etc.) in which hidden content may be available for viewing and/or temporarily unhidden. Upon deactivating a safe mode, a media application may re-hide the content marked for hiding and revert the interface configuration (e.g., display settings).

As described herein, a media application may include hardware, software, firmware, and/or any combinations of components thereof, where any of the involved systems may perform one or more of actions of the described techniques without departing from the teachings of the present disclosure. It is noted and appreciated that reference to a media application is provided for conciseness and may refer to one or more parts of the media application, and combinations thereof, that performs the described actions. Some non-limiting examples are described as follows. For example, a media application may include a locally hosted application at a user device. For example, a media application may include a virtual network between various devices. For example, a media application may include a remote application such as a content delivery system hosted at a server communicatively coupled with one or more user devices and other systems linked to a user device, where the content delivery system provides instructions that are transmitted to the user devices and executed by the relevant systems at the location of the user devices. For example, a media application may include a subsystem integrated with user equipment. For example, a media application may include a local application hosted at user equipment and a remote system communicatively coupled therewith.

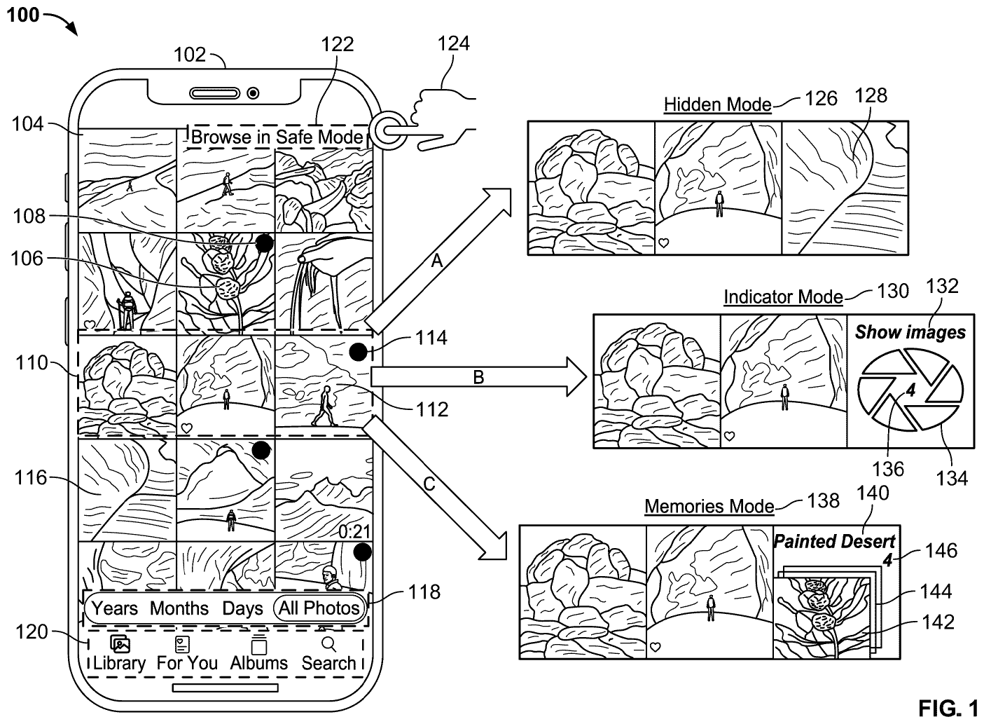

FIG. 1 shows an example scenario 100 depicting some configurations for hiding/unhiding content based on metadata, in accordance with some embodiments of this disclosure. At the scenario 100, a user device 102 may display a user interface (UI) 104 including visual content (e.g., images/video content items 106, 112, 116). While reference is made to a media application for brevity, it is noted and appreciated that the media application may be hosted at the user device 102 or otherwise communicatively coupled to the user device 102. For example, the media application may be hosted at a server and cause the user device 102 to perform various actions as described in the foregoing paragraphs via one or more instructions transmitted to the user device 102. The UI 104 may comprise a plurality of UI elements. For example, the UI 104 may comprise indicator UI elements 108 and 114 which indicate that the associated content items should be hidden. The UI elements 108 and 114 may comprise a graphical element (e.g., a dot, an open circle, a checkmark, a lightbulb, a closed eye icon, a crossed-out eye, an eyepatch, an icon, an animation, an emoji, a symbol, etc). In some embodiments, the UI elements 108 and 114 are not shown in the UI 104 (e.g., while scrolling through an album). In some embodiments, a media application causes to be displayed (e.g., via the user device 102) the UI elements 108 and 114 at the UI 104 based on detecting a focus on a hidden content item (e.g., content item 106) and/or on a content item (e.g., unhidden content item 116) related to a hidden content item (e.g., content item 112). The UI 104 may arrange display of the content items (e.g., photos, videos, etc.) in a grid, a carousel, a circle, and/or other display formats.

One or more UI elements (e.g., indicators such as UI elements 108 and/or 114, selectable options such as UI elements 118, 120, and 122) may be configured to be interactive and/or dynamically modifiable based on one or more criteria. For example, the UI 104 may comprise one or more portions having selectable options (e.g., options corresponding to the UI elements 118, 120). At the scenario 100, the UI element 118 may comprise one or more criteria for filtering, organizing, and/or sorting the displayed content items based on metadata. For example, the UI element118 may include interactive labels “Years,” “Months,” “Days,” and “All Photos” corresponding to grouping the items based on the corresponding metadata values. For example, a media application may group photos and videos based on capture year based on receiving a selection of “Years.” The UI element 120 may include one or more interactive elements for selecting a UI category. For example, a media application, based on a selection of the label “Albums,” may generate for display one or more albums that group content items based on having the same metadata value(s). In one example, the media application may generate an album labeled “Grandma's Birthday” that includes the content items having same or similar values, such as event, location, date, etc., in the metadata (e.g., values corresponding to keywords “Grandma” and/or “Birthday”).

In some embodiments, the UI 104 may comprise an interactable UI element 122 corresponding to an option to activate a safe mode (e.g., labeled “Browse in Safe Mode”). In some embodiments, the UI element 122 does not comprise a textual component. The UI element 122 may be visually indicative that a selection activates one or more configurations for displaying hidden and unhidden content without a textual label. For example, the UI element 122 may comprise one or more graphical parts including an icon, an animation, a button, a switch, a digital representation of an LED, etc. For example, the UI element 122 may depict a colored light in which the displayed color indicates which content display mode is active. In this example, the media application may cycle the display modes based on selecting the UI element 122. Continuing the scenario 100, the media application, upon receiving an interaction 124 via the UI 104, activates, changes, or deactivates the content display mode and/or modifies the displayed content items accordingly.

At the scenario 100, configurations A, B, and C are shown for illustrative purposes (respectively labeled hidden mode 126, indicator mode 130, and memories mode 138). A portion 110 of the UI 104 is highlighted to illustrate the effects of each configuration A, B, or C on the display of the hidden and unhidden content. It is contemplated that various display configurations and/or combinations thereof may be implemented without departing from the teachings of the present disclosure.

The UI 104 may rearrange the displayed content items in various ways based on the active display mode. For example, if hidden mode 126 is active, item 112 may be hidden based on indicator 114. The subsequent unhidden content item 116 may be arranged to be displayed at the position of the hidden item 112. In hidden mode 126, item 112 is not available for display and the UI 104 does not indicate presence of the hidden item 112.

In some embodiments, a media application, via the UI 104, may rearrange the displayed content items in various ways based on the active display mode. For example, referring to highlighted portion 110, if hidden mode 126 is active, the media application may determine to hide display of item 112 based on indicator 114. The media application rearranges the displayed content such that the subsequent item 116 is displayed at the position of the hidden item 112. In hidden mode 126, item 112 is not available for display, and the UI 104 does not indicate presence of the hidden item 112. In some embodiments, the media application is configured to prevent display of a hidden content item and/or prevent indicating presence of the hidden content item (e.g., item 112).

As a second, non-limiting example, referring to highlighted portion 110, if indicator mode 130 is active, the media application may determine to hide display of item 112 in an analogous manner. In this example, the media application may cause display of a UI element 132 at the position of item 112. The UI element 132 may comprise a textual element (e.g., “Show images”), a graphical element (e.g., graphic 134), and/or an element showing how many items are hidden (e.g., icon 136). In some aspects, the media application may offer for display or otherwise indicate that a hidden content item is available while indicator mode 130 is active. In indicator mode 130, item 112 is available for display, and the UI 104 indicates presence of the hidden item 112 and/or other hidden content. In some embodiments, the media application is configured to reveal a content item based on an interaction with the UI 104. For example, the media application may unhide the content items (e.g., items 106, 112, etc.) in response to receiving a selection of the UI element 132. The media application may rearrange display of the revealed content items to position the items 106, 112 adjacent to one another (e.g., starting from the position of item 112). For example, in a grid format, the revealed content items may be grouped in a block next to and/or around the position of item 112.

As a third, non-limiting example, referring to highlighted portion 110, if memories mode 138 is active, the media application may cause display of a UI element 140 at the UI 104 that indicates presence of hidden content items including hidden item 112. In this example, the UI 104 may display the UI element 140 at the position of hidden item 112. For example, the media application may reveal one of the hidden items at the UI element 140 (e.g., item 106 as a preview 142). In some embodiments, the media application may generate for display a label based on one or more keywords related to the hidden items (e.g., labeled “Painted Desert” based on location metadata of the hidden items). The media application may visually indicate presence of additional hidden content (e.g., using icon 144 depicting overlapping frames behind the preview 142 and/or a number icon 146 corresponding to the number of hidden items). The UI element 140 may be interactable in an analogous manner as the UI element 132. In memories mode 138, item 112 is available for display, and the UI 104 indicates presence of the hidden item 112 and/or other hidden content. In some embodiments, the media application is configured to reveal a content item based on an interaction with the UI 104. For example, the media application may unhide the content items (e.g., items 106, 112, etc.) in response to receiving a selection of UI element 140. The media application may rearrange display of the revealed content items to position the items 106, 112 adjacent to one another (e.g., starting from the position of item 112). For example, in a grid format, the revealed content items may be grouped in a block next to and/or around the position of item 112.

In some embodiments, a media application receives a selection of an option to display hidden content (e.g., via the UI 104 at the user device 102). In response to receiving the selection, the media application may unhide one or more hidden content items, and display the one or more content items in an interface. For example, the user device 102 may detect interaction 124 via the UI 104. In this example, the interaction 124 may include selection of an option (e.g., corresponding to the UI element 122) to enable a safe mode (e.g., any of modes 126, 130, 138). The media application may update, modify, and cause display of the content items and/or UI elements at the UI 104 according to the active mode. In some embodiments, the media application may cause display of an indicator that one or more hidden content items are available for display. The indicator may comprise an identifier indicating that the one or more hidden content items are related. For example, the media application may cause display of the indicator 108 at item 106 as a first icon. The media application may cause the same first icon to be displayed at other hidden items that are related to the item 106 (e.g., based on having the same metadata value for an event in corresponding metadata). For example, if the event is a party, the first icon may be a party popper or another party-related symbol. It is noted that the provided examples are intended to be illustrative and non-limiting. It is contemplated that there are various icons that may indicate content items are related based on metadata, and any of them, including combinations thereof, may be implemented without departing from the teachings of the present disclosure.

In some embodiments, a media application temporarily unhides at least a subset of hidden content items. For example, the media application may execute a temporary auto-unhide function on one or more images (e.g., items 106, 112) at a private storage location (e.g., a hidden folder). For example, the media application may determine one or more user interactions via a user device (e.g., while a user is browsing a photo album) while a safe mode (e.g., memories mode 138) is active. Upon deactivation of the safe mode, the media application may re-hide the content marked as hidden, reverting the display settings to the prior configuration.

In some embodiments, one or more of the content items to be displayed in a user interface are stored remotely (e.g., at a remote server). Additionally, or alternatively, the content items may be stored at different locations. For example, some items are stored in local memory of a user device, and some items are stored at one or more remote devices (e.g., stored in cloud-based memory, shared content between other devices and/or user profiles, various client/server configurations, etc.). The media application may access, display, modify, hide, and/or execute interactions with the content items via a single interface (e.g., the UI 104 displayed at the user device 102).

In some embodiments, a content item is hidden by visually distorting (e.g., blurring, redacting, censoring, etc.) display of the content item in the interface. The media application may generate a UI element comprising the visually distorted display of the content item. For example, in indicator mode 130, the media application may generate a blurred version of a hidden photo (e.g., item 112) for display as part of the UI element 132. In some embodiments, a media application identifies a plurality of content items related to a first hidden content item and modifies display properties to hide the plurality of content items such that the displayed content items are unrecognizable. For example, the media application may add visual noise to parts of the UI 104 that hides items 106, 112. The media application may generate a UI element (e.g., an indicator) comprising the visually modified content item during a safe mode (e.g., a blurred version of hidden item 106 as the preview 142). As an illustrative example, a media application may identify a photo (e.g., unhidden content item 116) as related to the hidden item 106. The media application may cause display of the photo to appear blurry to an extent that renders the photo unrecognizable (e.g., by adding a filter, removing or replacing one or more portions, adding visual noise, desaturation, masking, etc.). In another non-limiting example, the media application may alter various display properties (e.g., color, contrast, saturation, etc.) of the photo. In some embodiments, the media application may alter one or more display properties (e.g., color, contrast, saturation, etc.) of one or more UI elements to an extent that prevents visual recognition of a content item. The media application may determine that the content item is sufficiently unrecognizable based on one or more visual distortion metrics (e.g., a signal-to-noise ratio, a visual fidelity level, a similarity score, perceptual hash comparison, a structural similarity index, a structural content similarity degree, etc.). For example, the media application may compare the unmodified displayed content item and the visually modified displayed content item and compute a structural content similarity degree based on the comparison. If the similarity degree is greater than a threshold, the media application may determine that the visually modified displayed content item is not recognizable and/or hidden. For example, the media application may generate respective hashes based on the visual data corresponding to the unmodified displayed content item and the visually modified displayed content item and compare the generated hashes.

In some embodiments, the media application may cause display of the content items in a safe mode based on one or more user interactions via an interface (e.g., via the user device 102). For example, the media application may invoke the safe mode based on detecting a scroll, a tap, a visual focus, and/or other interactions indicative of a user browsing an album. In this example, the media application may determine that there are hidden pictures among the images that are being displayed at a device screen or at a viewport of a head-mounted display device (HMD). As an illustrative, non-limiting example, an iPhone® Pro Max screen (e.g., at user device 102) may be configured to display thumbnails of 18 to 40 images, videos, and other visual content (e.g., by adjusting the zoom in/out settings). One or more content items may be stored in a hidden folder location (e.g., on local memory of the iPhone® Pro Max device) to mark that the one or more content items are hidden. If the metadata of at least one content item at the hidden folder location (e.g., the date/time metadata values) match a selected range, such as the date/time of the first and the last images shown on the screen, then the media application may cause to be displayed an indicator or other UI element of a hidden image at the iPhone® Pro Max screen. Some example indicators can include a marker, a text, an image, an icon, a highlight, etc., which visually indicates that at least one hidden item is available for display and/or retrieval. For example, the marker can include a generic thumbnail that depicts an image unrelated to the hidden item(s). The media application may position that marker among a group of displayed items at the iPhone® Pro Max screen based on the metadata (e.g., time/date) of the hidden item(s). It is contemplated that a plurality of indicators (e.g., thumbnails) may be displayed in an analogous manner. The number of indicators may be based on a number of hidden content items in the current display screen. For example, the number of indicators may correspond to the number of images with date/time values in the metadata that fall between the first and last displayed images (e.g., icon 136). In some embodiments, the media application may determine that the hidden content items are displayed consecutively (e.g., positioned one after another at one or more rows in a grid display format when sorted based on their date/time metadata). The media application may cause to be displayed a single indicator or other UI element comprising the number of the hidden content item(s), for example, that would be displayed consecutively.

In some embodiments, a media application enables display of hidden content based on one or more user interactions with currently displayed content items. For example, if a filter is selected that groups displayed content based on a selected location metadata value, the media application may identify hidden content associated with the selected location. The media application may cause to be displayed an interactive indicator that the hidden content is available based on the corresponding location metadata being related to the currently displayed content. For example, one or more currently displayed images may depict a first location and be associated with the first location (e.g., have a depicted location value in metadata). The first location may be the same as or within a threshold distance of a second location (e.g., a capture location value in metadata) associated with one or more hidden photos captured at the second location. The interactive indicator may be selectable via an interface (e.g., the UI 104). The media application may reveal the hidden photos based on receiving a selection of the interactive indicator. The revealed photos may be hidden at a later time based on subsequent interactions. As another non-limiting example, a media application may detect interactions indicative of browsing pictures associated with a selected event type (e.g., birthday parties). In an analogous manner, the media application may identify hidden photos, videos, and the like that depict a birthday party (e.g., any birthday party or a selected party such as Grandma's birthday). The identified content can be displayed at a device (e.g., the user device 102) during browsing in a safe mode by temporarily unhiding and displaying the identified content (e.g., videos captured from a friend's birthday party).

It is noted that hiding a content item from display may be performed without moving the content item to a hidden folder or other private storage location. For example, a media application may receive a selection of an option to lock a content preview (e.g., a click via a user interface at a device). The media application prevents display of the content item and associated previews. In some embodiments, the media application generates a prompt for a password to authorize showing of the content item. The media application may automatically blur display of the locked content, for example, by increasing the transparency of an image of the content item at a corresponding UI element at the user device.

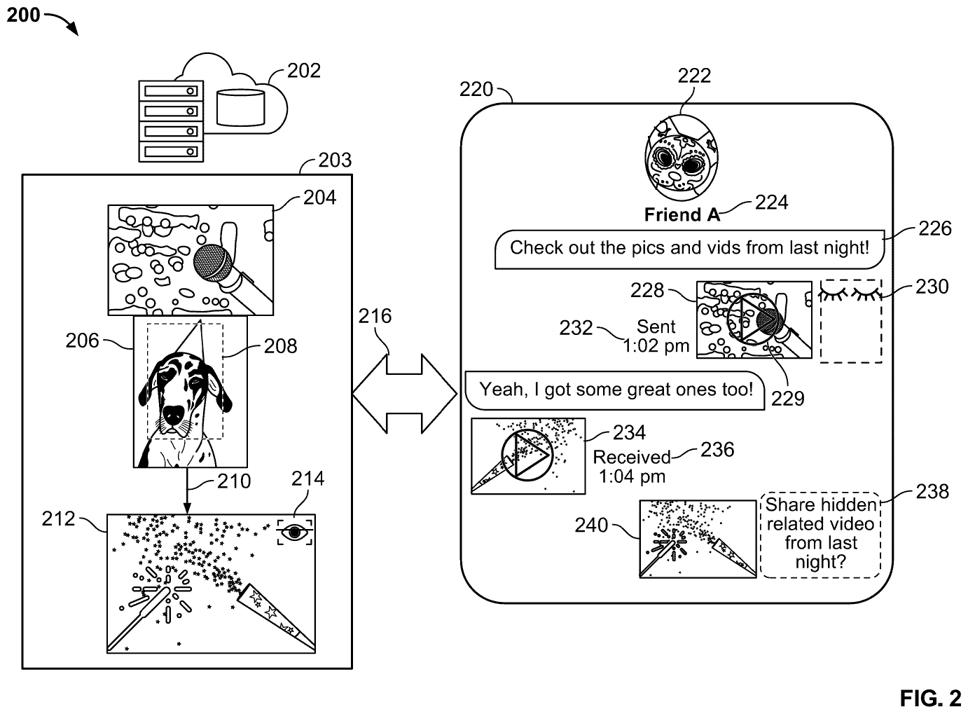

In some embodiments, a media application may hide content items in electronic communications and associated interfaces (e.g., text messages, iMessages, WhatsApp messages, emails, slideshows, screen sharing, etc.). Some example interfaces include a slideshow display, a messaging interface, a social media interface, a conferencing interface, etc. A communication interface may display content from received/sent communications as described regarding FIG. 2. In some embodiments, a media application, via the communication interface, reveals hidden content according to a selected display configuration as described regarding FIGS. 1-2.

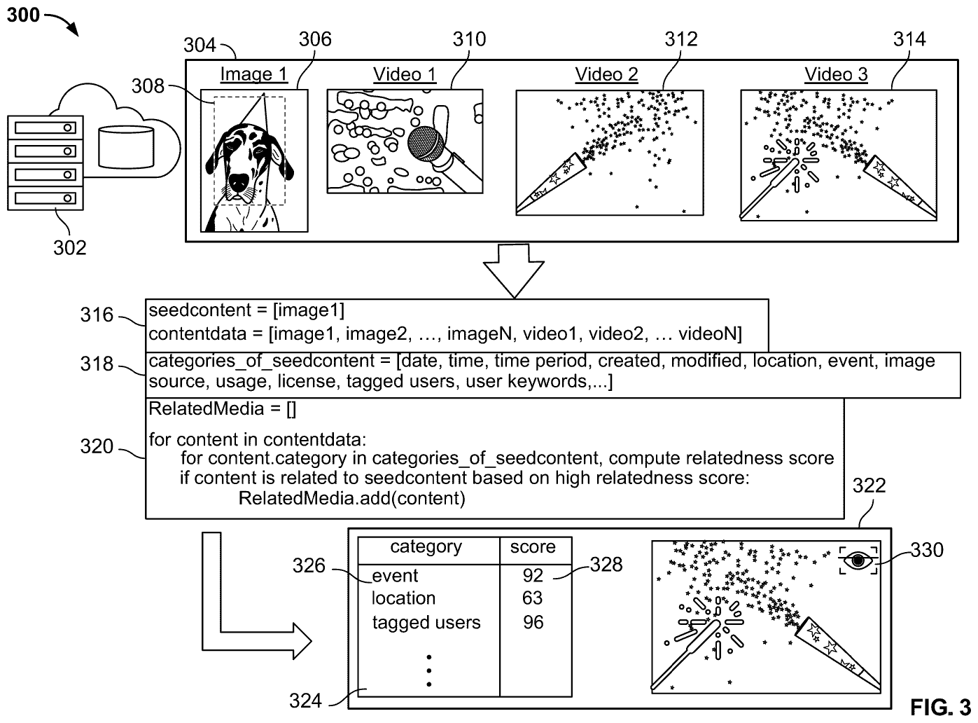

FIG. 2 shows an example scenario 200 depicting a communication interface 220 including related content sharing, in accordance with some embodiments of this disclosure. At the scenario 200, a server 202 or other remote device provides back-end processing related to a media application (e.g., a messaging application) having the interface 220. The server 202 may be communicatively coupled to one or more interfaces and/or devices including the interface 220 (e.g., via one or more communication paths 216 configured to exchange various content, metadata, and/or other data packets). The interface 220 may be displayed at a user device (e.g., the user device 102). The server 202 receives an input 203. The input 203 may comprise one or more content items (e.g., video 204, photo 206) and associated metadata. Based on the input 203, the media application may determine a related content item (e.g., video 212 being related to a face identifier 208 from photo 206) via a process 210. As part of the process 210, the media application may execute one or more relatedness analysis algorithms as described regarding FIG. 3. At the scenario 200, video 212 may be a hidden content item as indicated by icon 214.

Scenario 200 illustrates an example communication interface as the interface 220. At the interface 220, a conversation is depicted between first and second user profiles, for example, respectively associated with a first user device and a second user device. The interface 220 may depict the conversation at the first user device (e.g., from a first user's perspective). Example message types include SMS, MMS, voice messages, video messages, synthesized messages, etc. In this example, messages aligned with the right margin may be sent by the first user profile to the second user profile, and messages aligned with the left margin may be received by the first user profile sent from the second user profile. The second user profile may be associated with one or more user identifiers displayed at the interface 220 (e.g., profile image 222 and/or a username 224).

As an illustrative example, a group of images from a message received via WhatsApp may be selected via a user device. A request to hide the selected images may be sent via the user device (e.g., by tapping an interactive hide icon). A media application may receive the request and automatically hide the selected images. For example, the media application may move the selected images from the WhatsApp media storage location to a second location assigned to hide content. For example, the media application may mark the selected images and prevent display of the hidden images in a user interface. The selected images may remain stored at the WhatsApp media storage location.

As a second, non-limiting example, a media application may auto-download content received in an MMS message to local memory of a device (e.g., saved in a photo album or a folder associated with a messaging interface or another application). In some instances, a media application stores received content from one or more messaging interfaces (e.g., as in WhatsApp, Snapchat, iMessages, etc.) in their respective storage locations (e.g., folders, albums, cloud-based directory, etc.). The received content may be displayed at a user device via a single interface that accesses the storage locations for the one or more messaging interfaces. For example, the media application may display images from a WhatsApp folder and a Snapchat folder at an iOS® device under My Albums in one interface (e.g., the UI 104). The media application may receive a selection of an option to hide one or more images from the MMS message and automatically moves the one or more images to a private storage location or otherwise marks the one or more images as hidden (e.g., by updating corresponding metadata to include a hidden tag).

At the scenario 200, the first user device sends a first message 226 and content items 204 and 206. Associated metadata may be sent concurrently with the first message 226 and the content items 204, 206. The server 202, via associated communication circuitry, may receive the first message 226 and the items 204, 206 as part of the input 203. The content items 204, 206 may be part of the first message 226 or sent as a second message in some instances. The server 202, via the communication circuitry, may transmit the first message 226 and content items 204, 206, and/or 212 to the second user device. The interface 220 may indicate a sent date/time via a UI element 232. The interface 220 may update the UI element 232 to show a received or read date/time based on receiving a corresponding indication from the interface at the second user device.

At the interface 220, the media application may generate an interactive UI element 228 corresponding to the content item 204. The interface 220 may add an icon 229 to video 228 that shows the content type (e.g., a play button for a video). In some embodiments, the media application may store any sent and/or received content items at the server 202 and generate a link for accessing the content items. For example, the UI element 228 may comprise a link allowing a user device to access the content item 204 at the server 202. In response to receiving a selection of the link via the user device, the media application may stream video/audio of the content item 204 to the user device.

At the scenario 200, item 206 may be hidden at the interface 220 based on detecting the face identifier 208. For example, processing circuitry via server 202 may execute one or more facial recognition algorithms based on the input 203 and determine the face identifier 208. For example, the media application (e.g., via control circuitry at server 202) may access the metadata corresponding to the item 206 and retrieve the face identifier 208. In this example, the media application may determine that the content item 206 is related to a metadata value (e.g., a tagged user ID) associated with the face identifier 208. The metadata value may correspond to one or more hidden content items (e.g., one or more images at a private storage location or otherwise marked as private). Based on determining the relation between the item 206 and the hidden content item(s), the media application may generate a UI element 230 indicating a hidden content item. The media application may generate a second interface at the second user device that is analogous to the interface 220. In some embodiments, the media application does not generate a UI element corresponding to the UI element 230 at the second user device and/or does not indicate that a hidden content item is available. The media application may prevent transmission and/or display of the item 206 to the second user device. As an example, an interface at the second user device may show a UI element corresponding to only the UI element 228 without indicating the item 206.

At the scenario 200, the first user device may receive a second message comprising a content item (e.g., transmitted via the server 202). The interface 220 may comprise a UI element 234 corresponding to the received content item. The interface 220 may indicate the receipt date/time (e.g., via UI element 236). In an analogous manner, the media application may add an icon indicating the content type for a content item corresponding to the UI element 234 (denoted the received content item).

At the scenario 200, a first user device may transmit (e.g., share via the server 202) content related to and/or similar to content from a second user device (e.g., a picture that is related and/or similar to a picture received from the second user device). For example, in response to receiving a picture or video associated with an event from last night, a media application may generate a recommendation indicating that a related picture(s) is available for sharing. In some embodiments, the media application may determine the related content based on a high relatedness or similarity score (e.g., greater than an associated threshold). In some advantageous aspects as described in the present disclosure, a media application may identify hidden related content that other approaches may miss (e.g., pictures and/or videos from the same event associated with different user profiles and/or captured via different user devices). A media application may automatically communicate metadata of transmitted content (e.g., via the server 202) via the communication interface. For example, the media application may automatically receive authorized access to the shared content metadata via the communication interface.

The media application may determine that the item 234 is related to another content item (e.g., identified based on the input 203). For example, as discussed in the foregoing description, the content item 212 may have been identified as related to the content item 206. The received content item may be associated with the same event as content item 212 (e.g., based on having the same metadata value(s)). The media application may determine that the received content item is related to the content item 212. In some embodiments, the content item 212 is a hidden content item (e.g., as indicated by the icon 214). In response to determining that the received content item is related to the content item 212, the media application may identify the content item 212 and generate a UI element 238 and a UI element 240 corresponding to the content item 212. For example, the UI element 238 may indicate that a video is available that is related to the received content item and/or may comprise a prompt for sharing the related video. For example, the UI element 240 mar comprise an interactive preview corresponding to the content item 212 that may be played in response to selecting the preview. For example, the UI element 240 may comprise an image (e.g., a photo, a video frame, an outline, etc.) from the content item 212. The media application may receive a user interaction confirming or canceling transmission of the identified content item 212 (e.g., via a tap to confirm or a swipe to cancel via the interface 220) and proceed based on the received user interaction. For example, the media application may generate and transmit (e.g., via the server 202) a third message (not shown) and/or associated instructions for causing display of a UI element corresponding to the UI element 240 at the second user device.

It is contemplated that any number of user profiles and associated devices may be included in the same conversation via a communication interface analogous to the interface 220 (e.g., as a group chat, a conference, a breakout session, etc.). It is noted that the input 203 may be received by the server 202 at any point during the conversation shown in communication interface 220. For illustrative purposes, one example data flow is described in the foregoing paragraphs, but it is contemplated that one or more variants of this example may be implemented without departing from the teachings of the present disclosure.

As an illustrative example, an application display may be configured to show thumbnails of 18 to 40 items including images, video, and other types of content. If a value for a metadata category of at least one hidden item is within a range and/or matches values of the same metadata category for the first and the last content item shown on the screen (e.g., a timestamp, media source, face ID, etc.), then an indicator of the at least one hidden item may be displayed. The indicator may be a marker, an icon, text, or another type that indicates at least one hidden item is available for display. For example, display circuitry (e.g., at user device 102) may generate for display a generic thumbnail at a position between the first and last content items that visually indicates the at least one hidden item. The position may be determined based on the arrangement of the displayed items (e.g., sorted based on the time and/or date). In some embodiments, the indicator includes unrelated visual content (e.g., a generic thumbnail or a stock image different from the hidden content) or a preview of one item of the hidden items. In some instances, multiple previews may be displayed. In some embodiments, the indicator may show the number of hidden items in the current view (e.g., number of images with a date/time within range of the date/time for the first and last displayed images or previews). For example, if the hidden content items include four images at adjacent display positions between a first and last image, the media application may generate for display an indicator at a single display position between the first and last images. In this manner, the indicator may occupy a single display position without occupying four different positions, which frees up display space. The indicator may visually indicate the number of the hidden images (e.g., a label “4,” four small lines, stacked outlines, etc.). It is contemplated that the described example is analogously applicable to various interfaces (e.g., a communication interface such as the interface 220). For example, the control circuitry may generate for display a UI element in a communication interface (e.g., the UI element 230) analogous to the aforementioned indicator (e.g., UI elements 132 and/or 140). In some embodiments, a media application may perform the actions described in response to receiving a request (e.g., identified from a text-based message, a multimedia message, an audio message, a video message, etc.). For example, the media application may parse text from the first message 226 and determine that one or more keywords (e.g., “pics,” “vids”) are indicative of a user intent or a content request. The media application may execute one or more natural language processing (NLP) algorithms (e.g., locally and/or remotely via the server 202 or another remote device) to identify the user intent or request. For example, the media application may transcribe an audio message, and the audio transcription may be analyzed in an analogous manner. In some embodiments, the media application may execute one or more audio analysis algorithms that directly analyze an audio message without transcribing the audio. In this example, the media application may generate a recommendation indicating the content item 212 for sharing (e.g., based on the second user profile and/or a context of the first message 226). As a non-limiting example, a text from Friend A may include a request, such as “Send me the photo that we took last night.” The media application, via one or more NLP techniques, may determine that one or more keywords from the text correspond to one or more metadata categories. In this example, the media application may determine that (i) “last night” indicates a metadata value for a time and/or date, (ii) “me” refers to Friend A, and (iii) “we” refers to a plurality of users including Friend A and the receiver. Based on the NLP analysis, the media application may generate one or more criteria for searching content having the matching metadata values (e.g., date: last night; user tags/face IDs: Friend A, first user device; content type: photo, image, picture). The media application may identify one or more matching content items (e.g., content item 212) and generate a recommendation (e.g., UI element 238) for sharing the identified content (e.g., a photo captured via the first user device last night that includes or is otherwise associated with Friend A, the receiver, or both).

In some embodiments, a media application may display a slideshow comprising one or more images, trailers, clips, etc., corresponding to content items in a safe mode. For example, the media application may play a plurality of content previews (e.g., for all items in an album, a selected subset of items via a filter) sequentially, in a randomized order, sorted by one or more metadata values, etc. In some embodiments, the media application may add audio/visual effects to the slideshow (e.g., background music, animations, display transitions, borders/frames, etc.). In some advantageous aspects, playing a slideshow in safe mode includes one or more hidden content items based on one or more selected metadata categories (e.g., matching a date/time range, associated with an event, featuring a selected person, etc.).

FIG. 3 shows an example process 300 for determining related content based on metadata, in accordance with some embodiments of this disclosure. Process 300 may be implemented as part of a media application, for example, hosted at a server 302 and/or at user equipment. At the process 300, the media application may receive an input 304 comprising a plurality of content items and corresponding metadata. In some embodiments, a media application may execute the process 300 to identify related content, including hidden content, based on metadata. For example, the media application may identify the content item 212 based on the content item 206 via the process 300. For example, one or more user devices may transmit messages via a communication interface comprising an image 306 and/or videos 310-312. In this example, video 314 may be stored via a cloud-based provider (e.g., Google Drive™, iCloud R, Dropbox, etc.) and associated with a first user profile. The server 302 may have access to the stored content via the cloud-based provider, digital rights data of the first user profile, etc. The media application, via server 302, may access the stored content and determine that video 314 is related to the image 306 in this example.

As an illustrative example, metadata for a content item may comprise a plurality of metadata categories, each metadata category having at least one metadata value. Some example metadata categories include a location, an event, a time period, a user identifier, geospatial coordinates, a tagged user ID, a content source, an usage type, a license type, or one or more keywords. A media application may receive a first image and/or associated metadata. The metadata may have five metadata categories, each having one metadata value. The media application may compare the first image to a content item (e.g., using one or more visual analysis techniques) and compare the five values of the first image to five corresponding values of the content item. Based on the comparisons, the media application generates similarity scores, for example, by measuring how many metadata values of the first image are the same or within a threshold range of corresponding metadata values of the content item. The media application may generate a similarity score for each metadata category that is compared (e.g., five similarity scores). In some embodiments, the media application generates a similarity score for a group of metadata categories based on the comparisons (e.g., a first similarity score for three of the five categories and a second similarity score for the other two of the five categories). Based on similarity scores, the media application may determine that the content item has a high relatedness for the first image (e.g., based on computing high similarity score(s)). It is appreciated that this illustrative example is intended to be non-limiting, and any number of metadata categories and metadata values may be accessible by the media application for comparison.

In some embodiments, a media application receives a request to hide content based on a first visual content item (e.g., labeled as seed content). At the process 300, the input 304 may comprise an image 306. At block 316, the media application may identify the image 306 as the seed content and a plurality of content items as candidates for search and comparison (e.g., labeled content data). It is contemplated that the plurality of content items may include the videos 310-314 and more content items associated with one or more user profiles (e.g., profiles involved in the same group chat). In some embodiments, the media application may receive a video comprising at least one video frame based on an input (e.g., a link for accessing a selected frame of the video, an input selecting a time in the video from a user device). In such embodiments, the media application may identify one or more video frames of the video (e.g., a key frame) as the seed content.

In some embodiments, the media application compares the first visual content item to each input content item and/or metadata associated with the first visual content item to metadata associated with each input content item. For example, the media application may compare a first image (e.g., image 306) to each of a plurality of content items (e.g., the content data including videos 310-314). As one example, the media application may compare metadata corresponding to a first video frame of a video to metadata of each of the one or more plurality of content items. In another non-limiting example, the media application may determine that visual content items (e.g., images, videos) are related by identifying the same user (e.g., via face ID, user tag) depicted in the visual content items. For example, the media application may determine that a user is tagged in an image. The metadata of the image may include a face identifier associated with a user profile. In this example, the visual content items may be related by having the same face identifier (e.g., detected based on a facial recognition technique).

At block 318, the media application may determine a plurality of metadata categories and corresponding metadata values for the seed content. For example, the media application may access metadata associated with the image 306 and identify a plurality of categories having metadata values. In some embodiments, the media application may identify metadata categories that are populated (e.g., have non-empty or non-zero values) for determining whether content items are related.

At block 320, the media application may execute one or more relatedness analysis algorithms (e.g., similarity analysis, common attribute analysis, visual similarity, etc.) based on the first visual content item and generate respective scores or other metrics to determine if content items are related and measure the degree of relatedness (e.g., based on similarity scores, number of attributes in common, visual match, etc.). For example, the media application may execute facial recognition to identify a face ID 308 from image 306, and/or the media application may retrieve the face ID 308 from the metadata at block 318. At block 320, the media application may compute a relatedness score by comparing the face ID 308 to one or more corresponding metadata values for the content data. In some embodiments, the media application may determine that a first metadata value (e.g., the face ID 308) is associated with a second metadata value (e.g., an event, location, user ID, etc.) and compare the second metadata value to corresponding metadata for the content data. For example, the media application may determine that the face ID 308 is associated with a birthday party event, identify one or more keywords associated with a birthday party event, and query the metadata for videos 310-314 to find a corresponding keyword (e.g., via fuzzy matching and/or other NLP techniques). For example, the media application may detect the same face ID of an actor/actress featured in a movie trailer of interest, and determine that the movie trailer is related to a plurality of content items depicting the actor/actress based on the face ID and/or other identifiers of the actor/actress (e.g., the actor/actress' name, a character name, a stage name, etc.). In some instances, the media application determines that the movie trailer has a high relatedness score with the one or more of the plurality of content items based on one or more identifiers of the actor/actress. It is noted and appreciated that the aforementioned relatedness analyses are not intended to be exhaustive, and any number, type, and/or combination of techniques may be applied to measuring the relatedness between content items without departing from the teachings of the present disclosure.

In some embodiments, a media application may receive a user request to hide content items based on metadata. For example, a user device may transmit the request to filter pictures by event type (e.g., party, beach day, hiking trip, etc.). In some aspects, content may be associated with one or more metadata categories in common (e.g., location, GPS coordinates, geospatial information, time/date, etc.). The media application may activate a display mode for hiding related content (e.g., a “Hide Similar Photos” mode) based on receiving the user request. For example, the media application may receive an input content item. The media application, based on the input content item, automatically generates a list of currently available content items and/or marks the content items for hiding based on the input content item. In an analogous manner, the media application may analyze video content based on one or more video frames and associated metadata (e.g., indicating the presence of one or more people). The media application may generate an index for metadata corresponding to a video and/or the one or more video frames. The media application may add links in the metadata, wherein the links enable access to the video frames.

In some embodiments, a media application may retrieve and/or sort videos based on metadata related to a seed content item (e.g., a portion of a video selected via a content timeline and/or a selected video frame). In some embodiments, the media application may assign a selected video portion and/or frame as a preview of a video content item (e.g., for display in a content album). In some embodiments, the media application may access one or more predefined criteria. Additionally, or alternatively, the media application automatically generates one or more criteria that are applicable to later received content (e.g., criteria based on relatedness scores within a threshold range of currently hidden content). For example, the media application may generate a filter based on a face ID. A newly captured photo, via a user device, may be uploaded to the server 302. The media application may determine that the photo matches the generated filter and may automatically hide the photo.

In some embodiments, the media application (e.g., via server 302) may apply one or more computer vision techniques (e.g., via a local artificial intelligence processor(s) at a smart device) to detect user faces and/or identify associated user profiles from the content items. In some embodiments, the media application may detect user-inputted face IDs, user tags, and other identifying information. For example, a user device may add one or more user identifiers (e.g., username, social media profile link, character name) in metadata (e.g., for facilitating a search and/or filter based on a user). In some embodiments, the media application scans a content library and adds one or more user identifiers to content metadata (e.g., for identifying people depicted in images and/or videos). The added user identifiers may be combined with various embodiments described herein.

At block 322, the media application generates one or more relatedness scores based on executing the one or more relatedness analysis algorithms. For example, the media application may generate a data structure 324 based on comparing metadata of image 306 and the video 314. The data structure 324 comprises a plurality of relatedness scores (e.g., similarity scores) corresponding to the plurality of metadata categories. For example, category 326 (labeled event) may have a score 328. The metadata categories may be a list of non-empty categories that image 306 and video 314 have in common. In some embodiments, one or more scores of the plurality of relatedness scores are aggregate metrics from the one or more relatedness analysis algorithms. For example, a first score (e.g., score 328) may be determined based on data corresponding to a plurality of metadata categories (e.g., via statistics and/or other data analysis techniques). The media application may normalize or otherwise modify the data corresponding to a plurality of metadata categories for determining the first score. For example, to determine the score 328 for the category 326, the media application may determine a similarity score between event metadata values of the image 306 and the video 314, and the media application may determine a visual match degree based on the face ID 308 and facial recognition of a depicted tagged user. The media application may generate the score 328 based on the similarity score and the visual match degree. In some embodiments, the metadata application generates a score (e.g., score 328) based on comparing values for a first metadata category (e.g., category 326) and one or more additional metadata categories related to the first metadata category (e.g., related to an event). For example, for the event category 326, the media application may compare and generate scores corresponding to locations, tagged user IDs, date, time, and other metadata between the image 306 and the video 314. The media application may generate score 328 based on the scores corresponding to the locations, tagged user IDs, date, time, and other metadata. Based on the one or more relatedness scores, the media application may determine that the image 306 and the video 314 have a high relatedness level. If the image 306 is hidden, the media application may mark the video 314 as hidden based on the high relatedness level as shown via indicator 330. The indicator 330 may correspond to a UI element. In some embodiments, the indicator 330 is not shown at a UI and is indicative of a metadata value, a flag, a tag, or other data in metadata associated with the video 314 from which the media application may determine that the video 314 is a hidden content item. Additionally, or alternatively, the indicator 330 comprises data about the relatedness level (e.g., the computed scores, a degree, a content identifier for the related item, etc.) between the image 306 and the video 314.

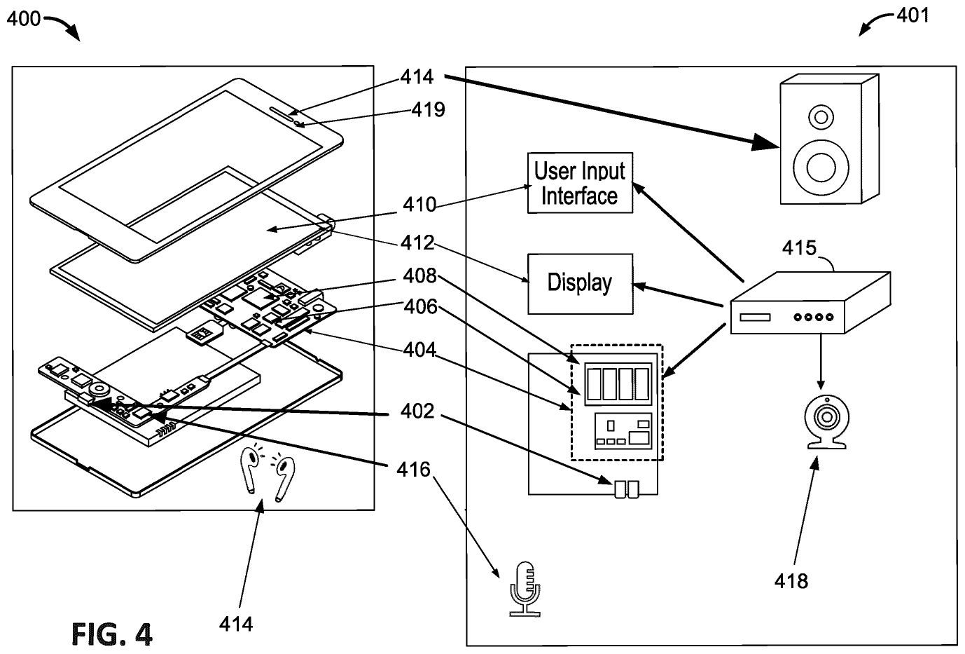

FIG. 4 shows generalized embodiments of illustrative user equipment devices 400 and 401, in accordance with some embodiments of this disclosure. For example, devices 400 and 401 may correspond to one or more user devices for displaying content in the present disclosure. In some embodiments, user equipment device 400 may be a smartphone device, a tablet, a virtual reality or augmented reality device, or any other suitable device capable of processing video data. In another example, user equipment device 401 may be a user television equipment system or device. User television equipment device 401 may include set-top box 415. Set-top box 415 may be communicatively connected to audio input equipment 416 (e.g., a microphone), audio output equipment 414 (e.g., speaker or headphones), and display 412. In some embodiments, display 412 may be a television display or a computer display. In some embodiments, display 412 may be a 3D display, such as, for example, a tensor display, a light field display, a volumetric display, a multi-layer display, an LCD display or any other suitable type of display, or any combination thereof. In some embodiments, set-top box 415 may be communicatively connected to user input interface 410. In some embodiments, user input interface 410 may be a remote-control device. Set-top box 415 may include one or more circuit boards. In some embodiments, the circuit boards may include control circuitry, processing circuitry, and storage (e.g., RAM, ROM, hard disk, removable disk, etc.). In some embodiments, the circuit boards may include an input/output (I/O) path.

Each one of user equipment device 400 and user equipment device 401 may receive content and data via I/O path (e.g., circuitry) 402. I/O path 402 may provide content (e.g., broadcast programming, on-demand programming, internet content, content available over a local area network (LAN) or wide area network (WAN), and/or other content) and data to control circuitry 404, which may comprise processing circuitry 406 and storage 408. Control circuitry 404 may be used to send and receive commands, requests, and other suitable data using I/O path 402, which may comprise I/O circuitry. I/O path 402 may connect control circuitry 404 (and specifically processing circuitry 406) to one or more communication paths (described below). I/O functions may be provided by one or more of these communication paths but are shown as a single path at FIG. 4 to avoid overcomplicating the drawing. While set-top box 415 is shown in FIG. 4 for illustration, any suitable computing device having processing circuitry, control circuitry, and storage may be used in accordance with the present disclosure. For example, set-top box 415 may be replaced by, or complemented by, a personal computer (e.g., a notebook, a laptop, a desktop), a smartphone (e.g., device 400), a tablet, a network-based server hosting a user-accessible client device, a non-user-owned device, any other suitable device, or any combination thereof.

Control circuitry 404 may be based on any suitable control circuitry such as processing circuitry 406. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. Any device, equipment, etc. described herein may comprise control circuitry. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for the media application stored in memory (e.g., storage 408). Specifically, control circuitry 404 may be instructed by the media application to perform the functions discussed above and below. In some implementations, processing or actions performed by control circuitry 404 may be based on instructions received from the media application.

In client/server-based embodiments, control circuitry 404 may include communication circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 4, the instructions may be stored in storage 408, and executed by control circuitry 404 of a device 400.

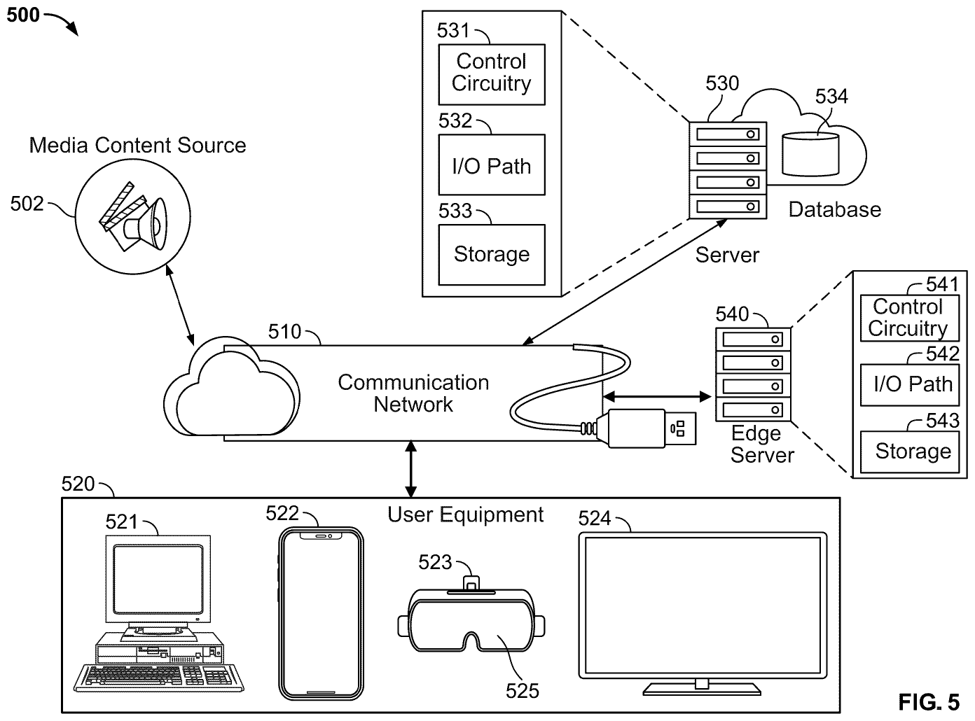

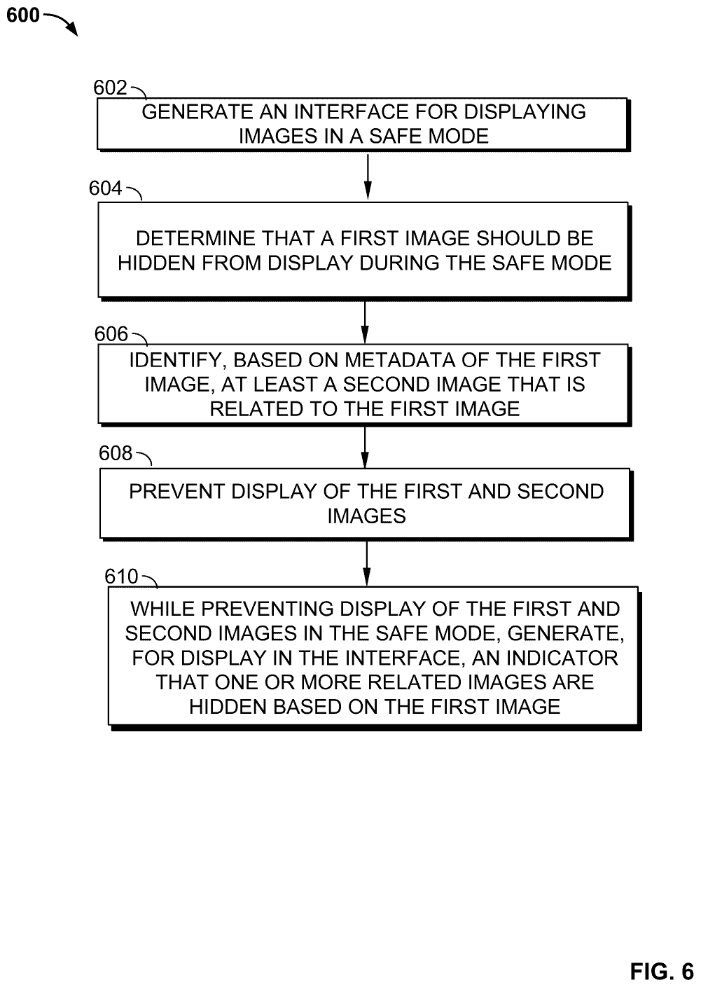

Control circuitry 404 may include communication circuitry suitable for communicating with a server, edge computing systems and devices, a table or database server, or other networks or servers. The instructions for carrying out the above-mentioned functionality may be stored on a server (which is described in more detail in connection with FIG. 6). Communication circuitry may include a cable modem, an integrated services digital network (ISDN) modem, a digital subscriber line (DSL) modem, a telephone modem, an ethernet card, or a wireless modem for communications with other equipment, or any other suitable communication circuitry. Such communications may involve the internet or any other suitable communication networks or paths (which is described in more detail in connection with FIG. 5). In addition, communication circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal videorecorders, or PVRs), solid state devices, quantum storage devices, gaming consoles, gaming media, or any other suitable fixed or removable storage devices, and/or any combination of the same. Storage 408 may be used to store various types of content described herein as well as media application data described above. Nonvolatile memory may also be used (e.g., to launch a boot-up routine and other instructions). Cloud-based storage, described in relation to FIG. 5, may be used to supplement storage 408 or in place of storage 408.

Control circuitry 404 may include video generating circuitry and tuning circuitry, such as one or more analog tuners, one or more H.265 decoders or any other suitable digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into a selected output format of user equipment 400. Control circuitry 404 may also include digital-to-analog converter circuitry and analog-to-digital converter circuitry for converting between digital and analog signals. The tuning and encoding circuitry may be used by user equipment device 400, 401 to receive and to display, to play, or to record content. The tuning and encoding circuitry may also be used to receive video encoding/decoding data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment device 400, the tuning and encoding circuitry (including multiple tuners) may be associated with storage 408.

Control circuitry 404 may receive instruction from a user by way of user input interface 410. User input interface 410 may be any suitable user interface, such as a remote control, mouse, trackball, keypad, keyboard, touchscreen, touchpad, stylus input, joystick, voice recognition interface, or other user input interfaces. Display 412 may be provided as a stand-alone device or integrated with other elements of each one of user equipment device 400 and user equipment device 401. For example, display 412 may be a touchscreen or touch-sensitive display. In such circumstances, user input interface 410 may be integrated with or combined with display 412. In some embodiments, user input interface 410 includes a remote-control device having one or more microphones, buttons, keypads, any other components configured to receive user input or combinations thereof. For example, user input interface 410 may include a handheld remote-control device having an alphanumeric keypad and option buttons. In a further example, user input interface 410 may include a handheld remote-control device having a microphone and control circuitry configured to receive and identify voice commands and transmit information to set-top box 415.

Audio output equipment 414 may be integrated with or combined with display 412. Display 412 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 412. Audio output equipment 414 may be provided as integrated with other elements of each one of device 400 and equipment 401 or may be stand-alone units. An audio component of videos and other content displayed on display 412 may be played through speakers (or headphones) of audio output equipment 414. In some embodiments, audio may be distributed to a receiver (not shown), which processes and outputs the audio via speakers of audio output equipment 414. In some embodiments, for example, control circuitry 404 is configured to provide audio cues to a user, or other audio feedback to a user, using speakers of audio output equipment 414. There may be a separate microphone 416 or audio output equipment 414 may include a microphone configured to receive audio input such as voice commands or speech. For example, a user may speak letters or words that are received by the microphone and converted to text by control circuitry 404. In a further example, a user may voice commands that are received by a microphone and recognized by control circuitry 404. The user equipment device 401 may include one or more cameras (e.g., camera 418). The user equipment device 400 may include one or more cameras (e.g., camera 419). The cameras 418 and 419 may be integrated with one or more components of a user equipment device, positioned at a body of a user equipment device, and/or include a stand-alone device that is communicatively coupled to one or more user equipment devices. For example, cameras 418, 419 may include any suitable video camera integrated with the equipment or externally connected. Cameras 418, 419 may include a digital camera comprising a charge-coupled device (CCD) and/or a complementary metal-oxide semiconductor (CMOS) image sensor. Cameras 418, 419 may include an analog camera that converts to digital images via a video card.

The media application may be implemented using any suitable architecture. For example, it may be a stand-alone application wholly implemented on each one of user equipment device 400 and user equipment device 401. In such an approach, instructions of the application may be stored locally (e.g., in storage 408), and data for use by the application is downloaded on a periodic basis (e.g., from an out-of-band feed, from an internet resource, or using another suitable approach). Control circuitry 404 may retrieve instructions of the application from storage 408 and process the instructions to provide encoding/decoding functionality and preform any of the actions discussed herein. Based on the processed instructions, control circuitry 404 may determine what action to perform when input is received from user input interface 410. For example, movement of a cursor on a display up/down may be indicated by the processed instructions when user input interface 410 indicates that an up/down button was selected. An application and/or any instructions for performing any of the embodiments discussed herein may be encoded on computer-readable media. Computer-readable media includes any media capable of storing data. The computer-readable media may be non-transitory, including, but not limited to, volatile and non-volatile computer memory or storage devices such as a hard disk, floppy disk, USB drive, DVD, CD, media card, register memory, processor cache, random access memory (RAM), etc.

In some embodiments, the media application is a client/server-based application. Data for use by a thick or thin client implemented on each one of user equipment device 400 and user equipment device 401 may be retrieved on demand by issuing requests to a server remote from each one of user equipment device 400 and user equipment device 401. For example, the remote server may store the instructions for the application in a storage device. The remote server may process the stored instructions using circuitry (e.g., control circuitry 531) and generate the displays discussed above and below. The client device may receive the displays generated by the remote server and may display the content of the displays locally on device 400. This way, the processing of the instructions is performed remotely by the server while the resulting displays (e.g., that may include text, a keyboard, or other visuals) are provided locally on device 400. Device 400 may receive inputs from the user via input interface 410 and transmit those inputs to the remote server for processing and generating the corresponding displays. For example, device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to device 400 for presentation to the user.

In some embodiments, the media application may be downloaded and interpreted or otherwise run by an interpreter or virtual machine (run by control circuitry 404). In some embodiments, the media application may be encoded in the ETV Binary Interchange Format (EBIF), received by control circuitry 404 as part of a suitable feed, and interpreted by a user agent running on control circuitry 404. For example, the media application may be an EBIF application. In some embodiments, the media application may be defined by a series of JAVA-based files that are received and run by a local virtual machine or other suitable middleware executed by control circuitry 404. In some of such embodiments (e.g., those employing MPEG-2 or other digital media encoding schemes), the media application may be, for example, encoded and transmitted in an MPEG-2 object carousel with the MPEG audio and video packets of a program.

FIG. 5 shows an illustrative system 500 for consuming content (e.g., visual content), in accordance with some embodiments of this disclosure. System 500 may include components for generating and providing content (e.g., graphics processor, integrated display, encoder, decoder, network components, content delivery networks (CDNs), etc.). System 500 may comprise media content source 502, one or more servers 530, and one or more edge servers 540 (e.g., included as part of an edge computing system). System 500 may comprise user equipment devices 520 (e.g., devices 521-524) and/or any other suitable number and types of user equipment capable of transmitting data by way of communication network 510.

In some embodiments, the media application may be a client/server application where only the client application resides on device 400, and a server application resides on an external server (e.g., server 530 and/or server 540). For example, the media application may be implemented partially as a client application on control circuitry 404 of device 400 and partially on server 530 as a server application running on control circuitry 531. Server 530 may be a part of a local area network with one or more of devices 520 or may be part of a cloud computing environment accessed via the internet. In a cloud computing environment, various types of computing services for performing searches on the internet or informational databases, generating virtualized components, providing encoding/decoding capabilities, providing storage (e.g., for a database) or parsing data (e.g., using machine learning algorithms described above and below) are provided by a collection of network-accessible computing and storage resources (e.g., server 530 and/or edge server 540), referred to as “the cloud.” Device 400 may be a cloud client that relies on the cloud computing capabilities from server 530 to receive and process encoded data for media content. When executed by control circuitry of server 530 or 540, the media application may instruct control circuitry 531 or 541 to perform processing tasks for the client device and facilitate the execution of the various processes (e.g., generating content for display, hiding content, encoding/decoding content, etc.).

Media content source 502, server 530 or edge server 540, or any combination thereof, may include one or more content processing devices (e.g., an encoder, graphics processing devices, etc.). The content processing devices may comprise any suitable combination of hardware and/or software configured to process data to reduce storage space to store the data and/or bandwidth to transmit the content data, while reducing the impact on the quality of the content being processed. In some embodiments, the data may comprise raw, uncompressed extended reality (3D and/or 4D) media content, or extended reality (3D and/or 4D) media content in any other suitable format. In some embodiments, each of user equipment devices 520 may receive processed data locally or over a communication network (e.g., communication network 510). In some instances, the devices 520 may comprise one or more converters (e.g., a decoder). Such a converter may comprise any suitable combination of hardware and/or software configured to convert received data to a form that is usable as video signals and/or audio signals or any other suitable type of data signal, or any combination thereof. User equipment devices 520 may be provided with processed data and may be configured to implement one or more machine learning models to obtain an identifier of an element in a data structure and/or render a color for a particular voxel based on the identified element. In some embodiments, at least a portion of processing may be performed remote from any of the user equipment devices 520.

User equipment devices 520 may include an illustrative head-mounted display or any other suitable XR device capable of providing media content for user consumption. Each of the user equipment devices 520 may access, transmit, receive, and/or retrieve content and data via one or more I/O paths coupled to the respective equipment using corresponding circuitry. As an illustrative example based on the device 521, a path to/from the communication network 510 may provide content (e.g., broadcast programming, on-demand programming, internet content, content available over a local area network (LAN) or wide area network (WAN), and/or other content) and data to control circuitry and/or communication circuitry of the device 521. In some embodiments, control circuitry of the device 521 may be used to send and receive commands, requests, and other suitable data using the path to/from the communication network 510 and the communication circuitry of the device 521. Such a path may communicatively couple control circuitry of the device 521 to one or more other communication paths. I/O functions may be provided by one or more of these communication paths but may be shown as a single path to avoid overcomplicating the drawing. One or more of the user equipment devices 520 may include or be coupled to a display device 523. In some embodiments, the display device 523 may comprise an optical system 525 of one or more optical elements such as a lens in front of an eye of a user, one or more waveguides, or an electro-sensitive plane. For example, the user equipment devices 520 may include an illustrative head-mounted display or any other suitable XR device capable of providing media content for user consumption.

In some embodiments, a media application may comprise and/or be communicatively coupled to an XR or other content processing framework. The XR framework may be executed at one or more of control circuitry 531 of server 530 (and/or control circuitry of user equipment devices 520 and/or control circuitry 541 of edge servers 540). The server 530 may be coupled to a database 534. In some embodiments, one or more data structures discussed herein may be stored at the database 534. The data structures may be maintained at or otherwise associated with server 530, and/or at storage 533 and/or at storage of one or more of user equipment devices 520. Communication network 510 may comprise one or more networks including the internet, mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 510) may separately or together include one or more communication paths, such as a satellite path, a fiber-optic path, a cable path, a path that supports internet communications (e.g., IPTV), free-space connections (e.g., for broadcast or other wireless signals), or any other suitable wired or wireless communication path or combination of such paths. Communications with the client devices may be provided by one or more of these communication paths but may be shown as a single path to avoid overcomplicating the drawing. Although communication paths may not be shown between user equipment devices, the devices may communicate directly with each other via one or more communication paths as well as other short-range, point-to-point communication paths, such as USB cables, IEEE 1394 cables, wireless paths (e.g., Bluetooth, infrared, IEEE 802-11x, etc.), or other short-range communication via wired or wireless paths. The user equipment devices may also communicate with each other directly through an indirect path via communication network 510.

In some embodiments, a media application may include a client/server application where only the client application resides on one or more user equipment devices 520, and a server application resides on an external server. For example, a media application may be implemented partially as a client application on control circuitry of a user equipment device 523 and partially on server 530 as a server application running on control circuitry 531. Server 530 may be a part of a local area network or may be part of a cloud computing environment accessed via the internet. For example, user equipment devices 520 may include a cloud client that relies on the cloud computing capabilities from server 530 to receive and process data for media content.

In some embodiments, server 530 may include control circuitry 531 and storage 533 (e.g., RAM, ROM, hard disk, removable disk, etc.). Storage 533 may store one or more databases. Server 530 may also include an input/output (I/O) path 532. I/O path 532 may provide protocol exchange data, device information, or other data, over a local area network (LAN) or wide area network (WAN), and/or other content and data to control circuitry 531, which may include processing circuitry, and storage 533. Control circuitry 531 may be used to send and receive commands, requests, and other suitable data using I/O path 532, which may comprise I/O circuitry. I/O path 532 may connect control circuitry 531 to one or more communication paths.

Edge computing server 540 may comprise control circuitry 541, I/O path 542 and storage 543, which may be implemented in a similar manner as control circuitry 531, I/O path 532 and storage 533, respectively, of server 530. Edge server 540 may be configured to be in communication with one or more of user equipment devices 520 (e.g., devices 521-524) and/or a video server (e.g., server 530) over communication network 510 and may be configured to perform processing tasks (e.g., encoding/decoding, display processing) in connection with ongoing processing of video data. In some embodiments, a plurality of edge servers 540 may be strategically located at various geographic locations and may be mobile edge servers configured to provide processing support for mobile devices at various geographical regions.

Control circuitry 531, 541 may be based on any suitable control circuitry. In some embodiments, control circuitry 531, 541 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 531, 541 executes instructions for an emulation system application stored in memory (e.g., the storage 533, 543). Although not shown, memory may be an electronic storage device provided as storage 533, 543 that is part of respective control circuitry 531, 541.

FIG. 6 is a flowchart of an example process 600 for indicating availability of hidden content based on metadata, in accordance with some embodiments of this disclosure. In various embodiments, the individual blocks of process 600 may be implemented at one or more components of the devices and systems of FIGS. 1-5. Although the present disclosure may describe one or more steps of process 600 (and of other processes described herein) as being implemented by specific components of the devices and systems of FIGS. 1-5, this is for purposes of illustration only, and it should be understood that other components of the devices and systems of FIGS. 1-5 may implement those steps. One or more blocks of the process 600 may correspond to one or more components as described regarding FIG. 1-5.

At block 602, control circuitry or another suitable circuitry (e.g., display circuitry at a user device) generates an interface for displaying images or other visual content in a safe mode. As one example, display circuitry may generate the interface as part of a media application. As a second example, processing circuitry associated with a remote server may generate the interface and display the interface at a user device. At block 604, the control circuitry determines that a first image should be hidden from display during the safe mode. For example, the control circuitry may identify a marker or other indicator to hide the first image (e.g., stored in associated metadata). At block 606, the control circuitry identifies, based on metadata of the first image, at least a second image related to the first image. At block 608, the control circuitry prevents display of the first and second images. For example, based on detecting that the first image should be hidden, the control circuitry may determine that the related second image should also be hidden. In response, the control circuitry may prevent display circuitry at a user device from generating the first and second images for display. Depending on the active display mode, the control circuitry may rearrange display of other images at the user device such that the interface appears to have no empty positions. At block 610, the control circuitry, while preventing display of the first and second images in the safe mode, generates an indicator for display in the interface. The indicator may show that one or more related images are hidden based on the first image. For example, display circuitry may generate for display, via an interface, a UI element indicating that the one or more related images are hidden based on the first image (e.g., UI element 140 at the mode 138).

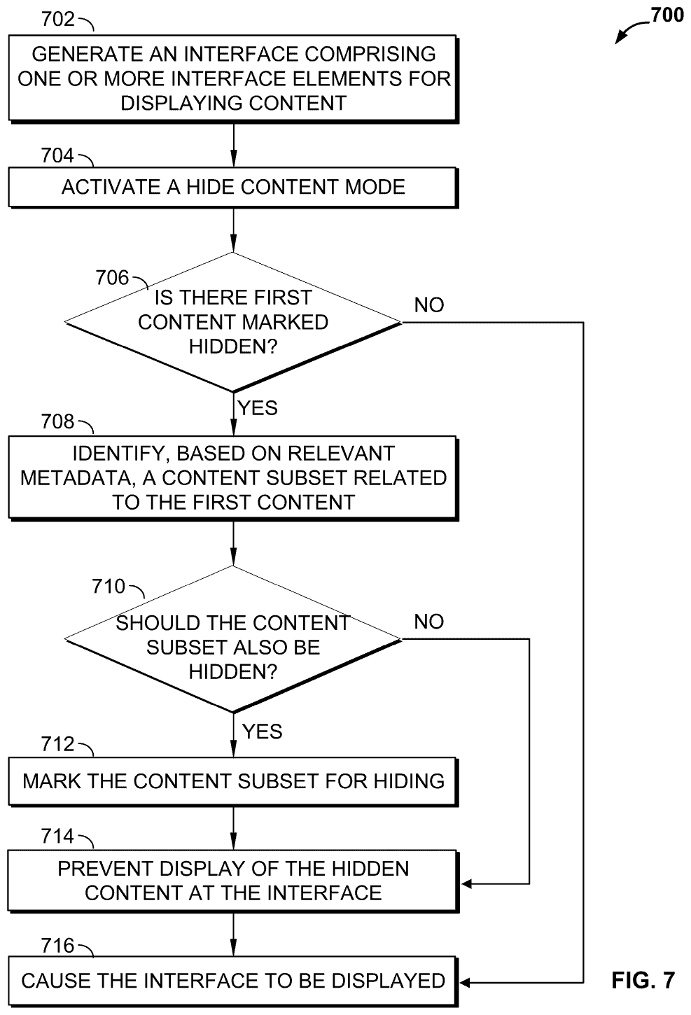

FIG. 7 is a flowchart of an example process 700 for hiding related content, in accordance with some embodiments of this disclosure. In various embodiments, the individual blocks of process 700 may be implemented at one or more components of the devices and systems of FIGS. 1-5. Although the present disclosure may describe one or more steps of process 700 (and of other processes described herein) as being implemented by specific components of the devices and systems of FIGS. 1-5, this is for purposes of illustration only, and it should be understood that other components of the devices and systems of FIGS. 1-5 may implement those steps. One or more blocks of the process 700 may correspond to one or more components as described regarding FIG. 1-5.

At block 702, control circuitry (e.g., control circuitry 404 at user device 400) generates an interface for displaying content. The interface may comprise one or more interface elements. For example, processing circuitry at and/or or coupled to the user device 102 may generate the UI 104 and the UI elements. The processing circuitry may modify (e.g., rearrange, resize, change graphics, adjust contrast, alter transparency, etc.) the UI 104 including one or more UI elements. In some embodiments, display circuitry at the user device 102 generates the UI 104 for display. In some client/server-based embodiments, control circuitry at a remote server may transmit one or more instructions configured to cause the user device 102 to execute various functions including displaying the UI 104 at the user device 102 and/or at an associated display device (e.g., a second monitor communicatively coupled to the user device 102).

At block 704, control circuitry may activate a hide content mode. The hide content mode may include one or more settings and alterations to a display configuration for ensuring that hidden content is not displayed. At block 706, control circuitry determines whether there is content marked hidden (e.g., a first content item). If no content item is marked hidden, the control circuitry may cause the interface to be displayed at block 716.

If a hidden content item is identified, the control circuitry continues to block 708. As an illustrative example, the UI 104 may be scrolled to browse a plurality of visual content items (e.g., organized in a content album). The UI 104 may be configured to queue content items for display. For example, in a grid format, the content items may be queued in the next row for display after moving a row of currently displayed content items out of the display. Control circuitry (e.g., at the user device 102) may determine that one or more hidden content items are in the display queue and/or may be displayed next. For example, control circuitry may identify a first content item (e.g., content item 106) and access metadata of the first content item. The control circuitry may determine that the metadata comprises a digital tag, a marker, and/or another indicator (e.g., corresponding to indicator 108, denoted a hide indicator henceforth) that the first content item should be hidden from display. At block 708, the control circuitry identifies a content subset (e.g., one or more content items queued for display, content items from a plurality of accessible content items) that is related to the first content item based on their respective metadata. For example, the control circuitry may perform one or more actions as described with respect to FIG. 3, such as generating one or more relatedness scores for a plurality of content items based on the first content item and corresponding metadata.

At block 710, the control circuitry may determine whether one, some, or all items of the content subset should be hidden (e.g., based on the first content item being indicated as hidden). In some embodiments, hiding the first content item may be associated with one or more criteria. The one or more criteria may be different from the criteria to determine whether the content items are related to the first content item. As an illustrative example, the hide indicator of the first content item may include criteria to hide the first content item based on metadata values matching a location, an event, and a tagged user ID. The control circuitry may access the metadata corresponding to one or more content items of the content subset and determine whether the metadata satisfies the location, event, and/or tagged user criteria. If the metadata does not satisfy the criteria, the control circuitry may continue to block 714 without marking any content item of the content subset for hiding. In some embodiments, the control circuitry may determine whether the metadata satisfies a threshold criterion amount and/or a selected criterion (e.g., matches two out of three criteria and/or matches at least a high priority criterion of the criteria).

If the control circuitry determines that the content subset comprises content items that should be hidden (e.g., satisfies the criteria), the control circuitry marks the content items for hiding at block 712. In some embodiments, the control circuitry updates or otherwise modifies the metadata, for example, by adding a hide flag to the metadata for the marked content items. Based on determining that one or more content items related to the first content item should be hidden, the control circuitry may prevent display of the hidden content at block 714. At block 716, the control circuitry causes the interface to be displayed (e.g., at a user device). The interface may display an indicator that hidden content is available for display based on an active safe mode. In some embodiments, the control circuitry prevents display of the hidden content and rearranges the displayed content to fill in one or more display positions where the content being hidden would have been displayed (e.g., as described regarding the mode 126 at FIG. 1).

As an illustrative example, a first hidden image may have a capture timestamp of 4:23 PM on Apr. 4, 20XX. Based on the sorting order, the first hidden image's preview (e.g., thumbnail) should be displayed in the grid between a first unhidden video captured at 4:15 PM and a second unhidden video captured at 4:33 PM from the same date. The control circuitry may determine that all content associated with Apr. 4, 20XX should be displayed based on user activity while browsing the content album. The user activity may include a user focus on related content items and/or receiving a user request for content belonging to that date. For example, a user, via the user device, may input a query for content associated with the event and the date (e.g., a voice input such as “Search for road trip memories from 4/4/20XX”). Based on the query, the control circuitry unhides the first hidden image's preview in the displayed results since the first hidden image has a capture date (e.g., Apr. 4, 20XX) matching the query. The control circuitry may hide the first image at a later time and/or based on the user activity. For example, the first image may be rehidden in response to determining that the user device has closed the album. It is contemplated that the described example is analogously applicable to various interfaces (e.g., a communication interface corresponding to interface 220).

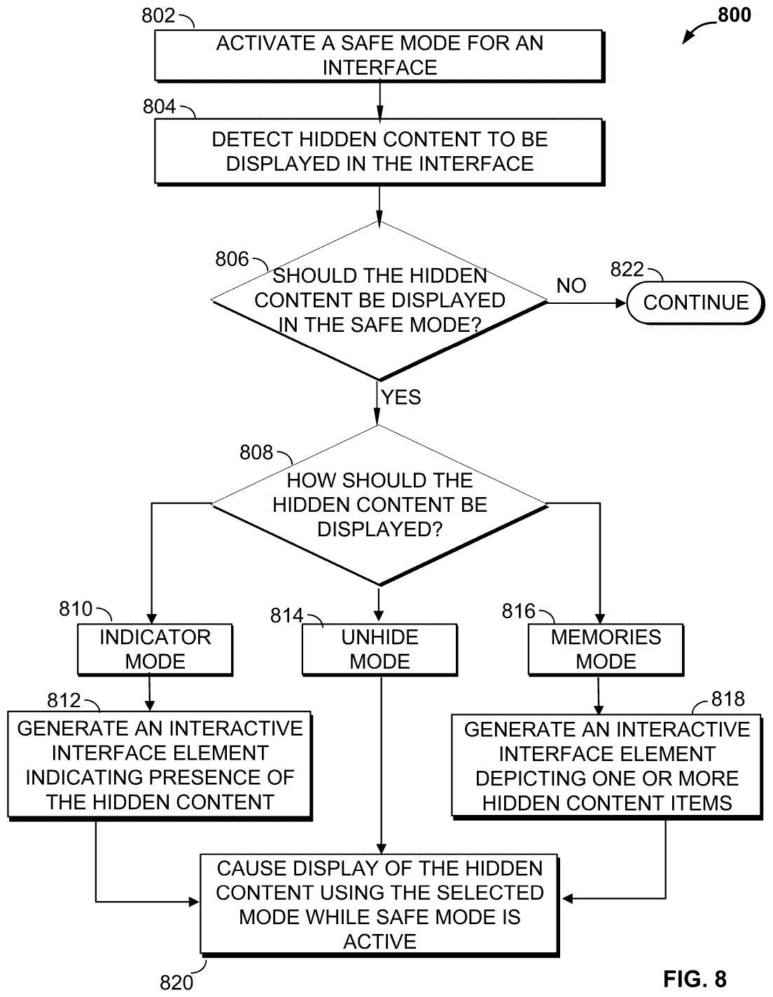

FIG. 8 is a flowchart of an example process 800 for unhiding hidden content in various configurations, in accordance with some embodiments of this disclosure. In various embodiments, the individual blocks of process 800 may be implemented at one or more components of the devices and systems of FIGS. 1-5. Although the present disclosure may describe one or more steps of process 800 (and of other processes described herein) as being implemented by specific components of the devices and systems of FIGS. 1-5, this is for purposes of illustration only, and it should be understood that other components of the devices and systems of FIGS. 1-5 may implement those steps. One or more blocks of the process 800 may correspond to one or more components as described regarding FIG. 1-5. In some embodiments, the process 800 may correspond to modifying an interface display configuration for showing content items at an interface.

At block 802, control circuitry activates a safe mode for an interface (e.g., based on the interaction 124 selecting the UI element 122). At block 804, the control circuitry may detect one or more hidden content items to be displayed in the interface (e.g., content items in a display queue having a hide flag in their respective metadata). At block 806, the control circuitry, based on the active safe mode, determines whether the hidden content should be displayed. If the hidden content should not be displayed, the control circuitry may continue to block 822 (e.g., entering to a monitoring state, initiating another process, reverting to a preceding block, etc.). For example, the control circuitry may determine that a first content item is unrelated to the displayed content and would not be displayed under the active display configuration corresponding to the active safe mode. For example, the control circuitry may generate only an indicator or other UI element to indicate that hidden content is available for display (e.g., the UI element 132 or 230). If the control circuitry determines one or more hidden content items should be displayed, then the control circuitry may determine a selected display configuration at block 808 based on the active safe mode. It is contemplated that, in some embodiments, blocks 806 and 808 may be performed in sequence, in parallel, concurrently, etc., without departing from the teachings of the present disclosure.

At block 808, the control circuitry may select at least one of the display configurations corresponding to an interface. Some example configurations are described at blocks 810, 814, and 816. At block 810, the control circuitry displays the content items in an indicator mode (e.g., the mode 130). In the indicator mode, the control circuitry at block 812 generates an interactive interface element (e.g., UI element 132) indicating presence and/or availability of the hidden content. In some embodiments, the control circuitry displays an image or other visual content item at the interactive interface element (e.g., an emoji, an icon, a thumbnail, etc.). The image or other visual content item may indicate a metadata category having the same value for the hidden content item(s). For example, the control circuitry may display an image of a party at the interactive interface element if at least some of the hidden content items are associated with a party event. The image or other visual content item may be unrelated to the hidden content item(s). For example, the control circuitry may display an animated GIF of a cat, and the hidden content item(s) are not associated with a cat. The control circuitry may access a visual content database (e.g., database 534, media content source 502) to retrieve the visual content item (e.g., a stock animation of a party, a video clip of a cat).

At block 814, the control circuitry displays the content items in an unhide mode. The control circuitry may reveal the hidden content items. In some embodiments, the control circuitry may position and/or sort the hidden content items at a UI (the UI 104) as if the hidden content items were not marked as hidden (e.g., without an indicator 114, at the same sorting level as the unhidden content items). In some embodiments, the control circuitry may group display of the hidden content items first, then sort the group of items according to the current settings.

At block 816, the control circuitry displays the content items in a memories mode (e.g., the mode 138). In the memories mode, the control circuitry may select one or more of the hidden content items to be revealed and displayed at a user device (e.g., via the UI 104, the display device 523). At block 818, the control circuitry generates an interactive interface element (e.g., the UI element 140) depicting one or more hidden content items. The control circuitry may select which hidden items to be displayed based on one or more user interactions (e.g., a visual focus, a gaze on a displayed content item for a threshold amount of time, a cursor hovering at a displayed content item). For example, the control circuitry may detect that a displayed item is highlighted via a user device and, in response, determines one or more of the hidden content items that are related to the displayed item (e.g., analogous to the process described at FIG. 3). The control circuitry selects the determined hidden items related to the displayed item and unhides the selected items for display via the user device (e.g., at a display device associated with the user device in some embodiments related to one or more screens or UIs coupled to user equipment). At block 820, the control circuitry causes display of the hidden content item using the selected mode or display configuration (e.g., blocks 810, 814, 816) while the safe mode is active. For example, control circuitry via a user device may generate for display the UI and selected UI elements. For example, display circuitry may generate for display the UI and selected UI elements. For example, in some client/server embodiments, the control circuitry transmits data comprising content data and/or one or more instructions configured to cause the relevant subsystems and associated circuitry to display a plurality of content items including the revealed content items.

It is contemplated that the control circuitry may display, modify, and/or prevent display of content at an interface in various configurations, and the examples described herein are intended to be illustrative and non-limiting. For example, a display configuration may comprise a combination including one or more settings from modes corresponding to the blocks 810 and 816.

As an illustrative example, control circuitry, via an interface at user equipment, may be configured to show thumbnails of 18 to 40 items including images, video, and other types of content. The control circuitry may determine that a value for a metadata category of at least one hidden item is within a range and/or matches values of the same metadata category for the first and the last content item shown on the screen (e.g., a timestamp, media source, face ID, etc.). In some instances, display circuitry generates for display an indicator of the at least one hidden item. The indicator may be a marker, an icon, text, or another type that at least one hidden item is available for display. For example, display circuitry (e.g., at device 401) may generate for display a generic thumbnail at a position between the first and last content items that visually indicates the at least one hidden item. The position may be determined based on the arrangement of the displayed items (e.g., sorted based on the time and/or date). In some embodiments, control circuitry may cause to be displayed multiple previews comprising visual content corresponding to the hidden content items. Control circuitry may generate an indicator that comprises the number of hidden items available in the current view (e.g., a number of images and videos with a date/time within a date/time range). For example, the control circuitry may determine that the hidden content items include four images at adjacent display positions and generate for display an indicator at a single display position of the four images. The indicator may visually indicate the number of the hidden content items (e.g., a label “4,” four small lines, stacked outlines, etc.).

In various embodiments, the individual steps of processes 600-800 may be implemented by one or more components of the devices and systems described with respect to FIGS. 1-5. For example, the processes 600-800 may be implemented, in whole or in part, by the one or more components of systems 100-500. While some steps of the processes 600-800 and other processes are described herein as being implemented by some components and/or devices, it is noted that this is for illustrative purposes, and it is understood that other suitable device and/or system components may be substituted without departing from the teachings of the present disclosure.

The systems and processes described herein are intended to be illustrative and not limiting. One skilled in the art would appreciate that the system components and/or steps of the processes discussed herein may be suitably substituted, omitted, modified, combined and/or rearranged. Components and/or steps may be added without departing from the scope of the present disclosure. More generally, the above disclosure is meant to be illustrative and not limiting. Only the claims that follow are meant to set bounds as to what the present disclosure includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
determining that one or more content items are hidden from display in a user interface;
enabling a safe mode for displaying content items;
detecting an interaction corresponding to the one or more hidden content items in the user interface while the safe mode is active; and
generating, for display in the user interface, an indicator that the one or more hidden content items are available for display.

2. The method of claim 1, further comprising:
receiving a selection of an option to display hidden content;
in response to receiving the selection:
unhiding the one or more hidden content items; and
displaying the one or more content items in the user interface.

3. The method of claim 1, wherein the indicator comprises an identifier that indicates the one or more hidden content items are related.

4. The method of claim 1, further comprising:
accessing metadata corresponding to a plurality of content items to be displayed in the user interface, wherein the plurality of content items to be displayed comprises the one or more hidden content items;
determining that at least one metadata value from the metadata indicates the one or more hidden content items are related;
updating the metadata corresponding to the one or more hidden content items to comprise an identifier that the one or more hidden content items are related based on the at least one metadata value; and
marking the one or more hidden content items as one or more related content items based on the identifier.

5. The method of claim 4, further comprising:
preventing display of one or more hidden content items that are unrelated to the one or more related content items.

6. The method of claim 4, wherein the one or more related content items comprise a first image, the method further comprising:
receiving a request to hide content based on the first image;
executing one or more relatedness analysis algorithms based on the first image;
generating, based on executing the one or more relatedness analysis algorithms, relatedness scores corresponding to the one or more related content items by:
comparing the first image to each content item of the one or more related content items; and
comparing metadata of the first image to metadata of each content item of the one or more related content items.

7. The method of claim 4, wherein the at least one metadata value comprises at least one of a location, an event, a time period, a user identifier, geospatial coordinates, a tagged user ID, a content source, a usage type, a license type, or one or more keywords.

8. The method of claim 7, wherein the tagged user ID comprises a face identifier of a user, and wherein each of the one or more related content items comprises at least the face identifier based on facial recognition.

9. (canceled)

10. The method of claim 1, wherein the indicator is indicative of how many content items are hidden.

11. The method of claim 1, wherein the user interface comprises a messaging interface.

12. A system comprising:
a user interface configured to display content; and
control circuitry configured to:
determine that one or more content items are hidden from display in the user interface;
enable a safe mode for displaying content items;
detect an interaction corresponding to the one or more hidden content items in the user interface while the safe mode is active; and
generate, for display in the user interface, an indicator that the one or more hidden content items are available for display.

13. The system of claim 12, wherein the control circuitry is further configured to:
receive a selection of an option to display hidden content;
in response to receiving the selection:
unhide the one or more hidden content items; and
display the one or more content items in the user interface.

14. The system of claim 12, wherein the indicator comprises an identifier that indicates the one or more hidden content items are related.

15. The system of claim 12, wherein the control circuitry is further configured to:
access metadata corresponding to a plurality of content items to be displayed in the user interface, wherein the plurality of content items to be displayed comprises the one or more hidden content items;
determine that at least one metadata value from the metadata indicates the one or more hidden content items are related;
update the metadata corresponding to the one or more hidden content items to comprise an identifier that the one or more hidden content items are related based on the at least one metadata value; and
mark the one or more hidden content items as one or more related content items based on the identifier.

16. The system of claim 15, wherein the control circuitry is further configured to:
prevent display of one or more hidden content items that are unrelated to the one or more related content items.

17. The system of claim 15, wherein the one or more related content items comprise a first image, and wherein the control circuitry is further configured to:
receive a request to hide content based on the first image;
execute one or more relatedness analysis algorithms based on the first image;
generate, based on executing the one or more relatedness analysis algorithms, relatedness scores corresponding to the one or more related content items by:
comparing the first image to each content item of the one or more related content items; and
comparing metadata of the first image to metadata of each content item of the one or more related content items.

18. The system of claim 15, wherein the at least one metadata value comprises at least one of a location, an event, a time period, a user identifier, geospatial coordinates, a tagged user ID, a content source, a usage type, a license type, or one or more keywords.

19. The system of claim 18, wherein the tagged user ID comprises a face identifier of a user, and wherein each of the one or more related content items comprises at least the face identifier based on facial recognition.

20. (canceled)

21. The system of claim 12, wherein the indicator is indicative of how many content items are hidden.

22. The system of claim 12, wherein the user interface comprises a messaging interface.

23-55. (canceled)
